(19) United States
(12) Patent Application Publication
(10) Pub. No.: US 2017/0243224 A1
(43) Pub. Date: Aug. 24, 2017

(54) METHODS AND SYSTEMS FOR BROWSER-BASED MOBILE DEVICE AND USER AUTHENTICATION

(71) Applicant: MasterCard International Incorporated, Purchase, NY (US)

(72) Inventor: Ashfaq Kamal, White Plains, NY (US)

(21) Appl. No.: 15/047,129

(22) Filed: Feb. 18, 2016

(51) Int. Cl. G06Q 20/40; G06Q 20/32; G06Q 20/10

(52) U.S. Cl. CPC G06Q 20/40145; G06Q 20/10; G06Q 20/322

(57) ABSTRACT

Methods and systems for authenticating both a browser-based user mobile device and the user in association with an online transaction. In an embodiment, the process includes receiving, by a cloud-based authentication service computer, a user authentication request from a user mobile device. A mobile transaction application determines that the user and the entity involved in the online transaction are enrolled in a cloud-based authentication service, identifies a user data structure and a user profile, determines that the received user authentication data and user mobile device identification data matches data stored in the user profile, and determines that a requirement of the entity is satisfied. The mobile transaction application then transmits a positive user authentication message to an entity computer.

### FIELD OF THE INVENTION

Embodiments described herein generally relate to strong user authentication techniques, and more particularly to methods and systems for authenticating both a browser-based mobile device and the user. Some embodiments relate to consumer device authentication and cardholder authentication for browser-based payment or purchase transactions.

### BACKGROUND

More and more transactions are conducted by a user, such as a consumer, operating a mobile device running browser software, such as a laptop computer, tablet computer, a smartphone, a digital music player, and the like. Such mobile devices may be utilized to perform a number of tasks, including payment or purchase transactions. Thus, it has become increasingly important that users involved in any such transactions be authenticated in order to prevent fraud. In some typical cases, the user is authenticated by entering a personal identification number (“PIN”) or mobile personal identification number (“mPIN”) or the like in accordance with an authentication protocol. In particular, entities such as payment card issuers and/or other financial institutions now offer and/or use standardized Internet transaction protocols designed to improve online purchase transaction performance, and such initiatives have accelerated the growth of electronic commerce. Under some standardized protocols, card issuers or issuing banks can authenticate payment or purchase transactions while also reducing the likelihood of fraud and associated chargebacks attributed to cardholder not-authorized transactions.

An example of a standardized Internet protocol for online transactions is the 3-D Secure Protocol. The 3-D Secure protocol is consistent with and underlies the authentication programs offered by certain payment card issuers (e.g., Verified by Visa™ or MasterCard SecureCode™) to authenticate customers for merchants during remote purchase transactions such as those associated with the Internet (commonly referred to as online transactions and/or e-commerce transactions and/or card not present (“CNP”) transactions). The presence of an authenticated purchase transaction may result in an issuer financial institution assuming liability for fraud (if it should occur despite efforts to authenticate the cardholder during an online purchase). Merchants are thus assured by payment card issuers (such as issuing banks) that they will be paid for issuer-authenticated online transactions even if a fraudulent activity occurs. For example, if a wrongdoer utilizes an electronic device in combination with a lost or stolen payment card to fraudulently conduct an online purchase transaction, and that wrongdoer and/or electronic device is authenticated by the card issuer such that the purchase transaction is consummated, then the issuer financial institution takes responsibility and pays the merchant for the fraudulent transaction. The financial loss in such a scenario is thus absorbed by the issuer financial institution instead of the merchant.

Accordingly, it would be desirable to provide a strong mobile device authentication and user authentication service for online and/or e-commerce and/or CNP transactions that provides users (such as consumers) with an improved user experience while also minimizing the exposure of entities (such as issuer financial institutions) to fraud (such as payment card lost and/or stolen fraud). It would also be desirable if such a strong mobile device authentication and user authentication service is configured such that it emulates a card present transaction.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of an embodiment of a transaction system that includes components for providing a cloud-based user authentication service according to some embodiments of the disclosure;

FIG. 2 is a block diagram of an embodiment of a user mobile device to illustrate some hardware aspects in accordance with the user authentication and user mobile device authentication processing in accordance with some embodiments of the disclosure;

FIG. 3 illustrates a user enrollment process in accordance with some embodiments of the disclosure;

FIG. 4 is a flowchart illustrating an entity enrollment process in accordance with some embodiments of the disclosure; and

FIG. 5 is a flowchart illustrating a user authentication process in accordance with some embodiments of the disclosure.

### DETAILED DESCRIPTION

In general, and for the purpose of introducing concepts of novel embodiments described herein, provided are systems, apparatus and methods that provide a strong user authentication and mobile device authentication service for entities (for example, online merchants and/or issuer financial institutions) for browser-based online transactions. The online transactions may involve a person or user utilizing a user mobile device (such as a smartphone, tablet computer, laptop computer, personal digital assistant (PDA), a wearable device such as a digital watch or digital fitness device, and/or a digital music player) to purchase a product or service from an entity. In accordance with disclosed embodiments, an improved online transaction user experience is provided while also minimizing the exposure of entities (such as merchants) to fraud. Throughout this disclosure, examples of financial transactions will be described. However, those skilled in the art will appreciate that embodiments may be used with desirable results for other types of transactions, such as transactions permitting a user access to a building and/or transactions which allow a user to enter a mass transit system (such as entry to a subway train station and/or to a public bus station).

A number of terms will be used herein. The use of such terms are not intended to be limiting, but rather are used for convenience and ease of exposition. For example, as used herein, the term “user” may be used interchangeably with the term “consumer” and/or the with the term “cardholder” and these terms are used herein to refer to a person, individual, consumer, business or other entity that owns (or is authorized to use) a financial account such as a payment card account (such as a credit card account or debit card account) or some other type of account (such as a loyalty card account or mass transit access account). In addition, the term “payment card account” may include a credit card account, a debit card account, and/or a deposit account or other type of financial account that an account holder or cardholder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other entities or organizations (and thus are known as issuer financial institutions or issuer banks). In addition, the terms “payment system transaction data” and/or “payment network transaction data” or “payment card transaction data” or “payment card network transaction data” refer to transaction data associated with payment or purchase transactions that have been or are being processed over and/or by a payment network or payment system. For example, payment system transaction data may include a number of data records associated with individual payment transactions (or purchase transactions) of cardholders that have been processed over a payment card system or payment card network. In some embodiments, payment system transaction data may include information such as data that identifies a cardholder, data that identifies a cardholder's payment device and/or payment account, transaction date and time data, transaction amount data, and indication of the merchandise or services that have been purchased, and information identifying a merchant and/or a merchant category. Additional transaction details and/or transaction data may also be available and/or utilized for various purposes in some embodiments.

In some implementations, improved cloud-based authentication techniques for online transactions are applied to users (persons who may be cardholders) and to user mobile devices (such as Smartphones) resulting in an improved online transaction experience for the users and for entities such as merchants. Some embodiments concern a strong online authentication service provided to merchants for online transactions. In some embodiments, a user transmits user identification data, user mobile device identification data, and transaction identification data to a cloud-based computer system running a transaction application (for example, a mobile payment application). The transaction application of the cloud computer system utilizes the transaction data to identify the transaction type and the entity involved in the transaction, and then may identify a pre-stored user profile that contains user profile data. In some implementations, the user profile data includes user identification data which may include biometric data, user mobile device identification data, and business rules data and/or policy data associated with the entity. The cloud-based online transaction application may utilize the business rules data to process the user identification data and/or user device identification data during the authentication process. Thus, in some embodiments, in furtherance of a transaction the transaction application running on the cloud-based computer system authenticates both the user and the user's mobile device when the user identification data and the user device identification data matches pre-stored data in accordance with the business rules data contained in the user profile data for a particular entity. When the user and the user's mobile device are authenticated, the cloud computer system transmits a positive user and user device authentication message to the entity (such as a merchant device of a merchant). Conversely, a negative authentication message may be transmitted to the entity when the user and/or user mobile device cannot be authenticated.

When a positive authentication message is received, the entity may then submit the transaction information (which may include some or all of the user identification data) to a transaction processing system (such as a payment network) for further processing for transaction authorization processing (for example, authorization of a purchase transaction by an issuer bank of a payment card account of the user). In some embodiments, in response to receipt of a positive authentication response, the entity may decide not to transmit the transaction information to a transaction processing system and instead unilaterally authorize the transaction in order to speed the transaction in accordance with a business rule. For example, if the entity is a merchant then that merchant may invoke a business rule directing automatic transaction authorization when a positive authentication message is received and the total transaction amount is equal to or less than a threshold value amount of money. In the case of a food store merchant, for example, such a threshold value may be twenty-five dollars or less. Thus, in this case the merchant authorizes the transaction instead of transmitting the transaction information to a payment network to ensure that the user has a good consumer experience.

In some embodiments, before any authentication processing occurs with regard to online transactions, users and/or entities (such as merchants) enroll or register for use of the cloud-based authentication service with a cloud-based computer system running the mobile device transaction application. In particular, as part of the online transaction authentication service enrollment or registration process, a user provides user identification data, cardholder account data, and user authentication data which may include, but is not limited to, one or more passwords, and one or more forms of biometric data (such as fingerprint data, iris data, voice data, facial data and the like). Entities enroll by providing entity identification data and user authentication rules data and/or business rules data and/or policy data, some or all of which may be included in one or more user profiles. In some embodiments, a user utilizes the capabilities of a user mobile device to provide various forms of authentication data. For example, the user mobile device may be configured to obtain one or more of location data, mobile device personal identification number (mPIN) data, pictorial data, finger print data, facial recognition data, voice data, and/or other types of biometric data for transmission to the cloud-based authentication service. In addition, some embodiments include identifying and then utilizing the sensor(s) or biometric components of a particular user mobile device (which will be described further herein) to allow identification of the appropriate user authentication process(es) to be used for a particular type of transaction for a given user and/or cardholder. Accordingly, one of many different types of cardholder verification methods (CVMs) may be utilized for a particular transaction which may depend upon one or more variables, such as the nature of the transaction, the entity or entities involved in the transaction, the transaction amount (if applicable), and/or other variables.

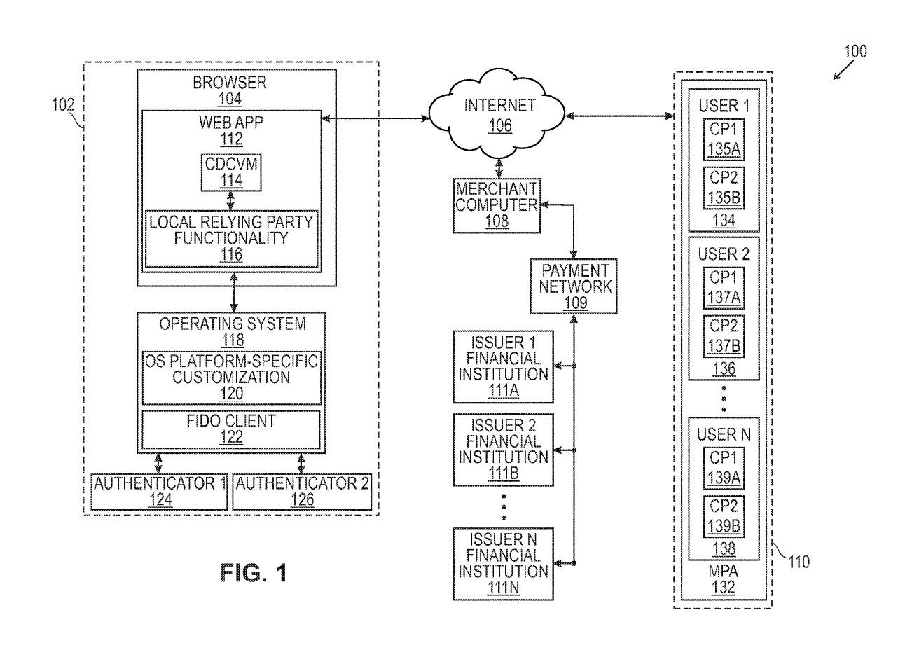

Features of some embodiments will now be described by reference to FIG. 1, which is a block diagram of an embodiment of a transaction system 100 that includes components for providing a cloud-based user authentication service according to some embodiments. In this example, the transaction system 100 involves a number of devices and/or components and/or apparatus of different parties and/or entities that interact with each other to conduct a purchase transaction. For example, a user (not shown) may operate a user mobile device 102 running a web browser 104 to interact with a merchant computer system 108 and/or with a cloud computer system 110 via the Internet 106. Also shown are a payment network 109 and issuer financial institution (FI) one 111A, issuer FI two 111B, and issuer FI “N” 111N. While only a single user mobile device 102, merchant computer system 108, payment network 109, and cloud computer system 110 are shown in FIG. 1, in practice, a large number of such devices and/or components may be involved and/or utilized in the transaction system 100 in accordance with embodiments described herein. It should also be understood that the computers and/or computer systems depicted in FIG. 1 may include one or many computers and/or server computers which may be organized into a system or network in accordance with considerations such as speed and/or accuracy of data handling. Thus, some or all of the computers and/or computer systems may be specially designed (or customized) to handle the data and/or information throughput and provide one or more output results in accordance with the processes described herein.

Referring again to FIG. 1, the user mobile device 102 includes browser software 104 which may include a web application 112. The web application 112 includes a consumer device cardholder verification method (CDCVM) module 114 and a local relying party functionality module 116. The local relying party functionality module 116 may operate to store data indicative of a repeat user with regard to, for example, a purchase transaction with a particular entity, such as a merchant. The Web application 112 operates in conjunction with the Operation System (OS) 118, which may include an OS platform-specific customization module 120 and a FIDO client 122. Pursuant to some embodiments, some of the components of the user mobile device 102 may be configured based on, or by using, the “FIDO” standards promulgated by the Fast Identity Online Alliance (available at www.fidoalliance.org, and incorporated herein by reference in their entirety for all purposes). However, it should be understood that other standards or implementations may also be used to provide suitable results. The user mobile device 102 also includes a first authenticator 124 and a second authenticator 126 operably connected to the operating system 118, wherein the authenticators may be biometric sensors (not shown), such as a fingerprint sensor and/or an optical sensor.

The cloud-based computer system 110 shown in FIG. 1 may include one or more processors and storage devices (not shown) that are configured for running a mobile payment application (MPA) 132 utilized for authentication processing. In some implementations, the mobile payment application includes a first user data structure 134, second user data structure 136, and so forth out to an “Nth” user data structure 138. Each of the plurality of user data structures 134, 136, 138 includes one or more consumer or cardholder profiles, wherein each such cardholder profile is associated with a particular entity or merchant. For example, the first user data structure 134 includes a first cardholder profile (CP1) 135A associated with a first entity, and a second cardholder profile (CP2) 135B associated with a second entity. In some implementations, the first entity represents a first merchant having certain rules and/or policies governing authorization of cardholders and/or consumers, whereas the second entity represents a different, second merchant having the same, similar or totally different rules and/or policies governing authorization of cardholders and/or consumers. Similarly, the second user data structure 136 includes CP1 137A associated with a first entity, and a CP2 137B associated with a second entity, wherein the first entity represents, for example, a first merchant having certain rules and/or policies governing authorization and the second entity represents a different, second merchant having the same, similar or totally different rules and/or policies governing authorization. The same applies to the Nth user data structure 138, which includes CP1 139A associated with a first entity, and CP2 139B associated with a second entity. It should be understood that, even though only two cardholder profiles (CP1 and CP2) are shown associated with each of the user data structures 134, 136 and 138, any number of such cardholder profiles could be included without limitation. For example, the first user data structure 134 could have fewer than the two cardholder profiles (CPI and CP2) that are shown, or could have more (such as cardholder profiles three and four, associated with additional entities).

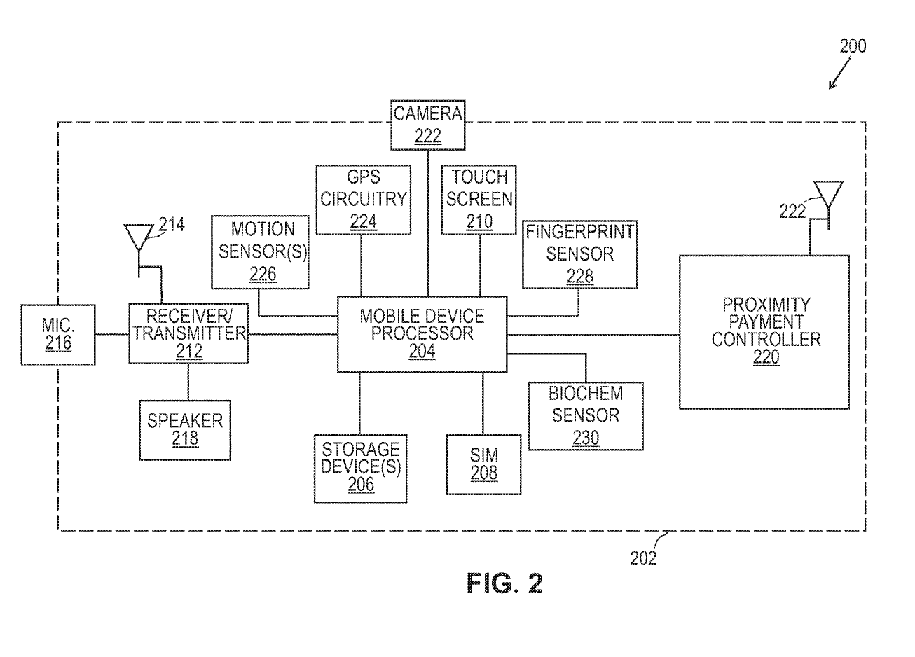

Referring again to FIG. 1, during a transaction a user or consumer controls the web browser 104 of his or her mobile device 102 (such as a Smartphone or tablet computer) to initiate, for example, a purchase transaction via a merchant website hosted by the merchant computer 108. For example, the user may select items for sale on the merchant's website page and those items may be stored in a virtual shopping cart (not shown) as the consumer looks for more merchandise to purchase. After making final selections of items and/or services, the user indicates a desire to check-out and/or purchase the selected items by utilizing the browser software 104 of the user's mobile device 102 to transmit a request for check-out (for transaction processing) to the merchant computer 108. In some embodiments, the merchant computer 108 transmits a request via the Internet 106 to the user's mobile device for user authentication processing and for user device authentication, which request causes initiation of the consumer device cardholder verification method (CDCVM) application 114 on the user's mobile device 102. The CDCVM application 114 may then prompt the user, for example via one or more messages on a display screen (not shown) of the user mobile device 102, to provide user biometric data by using one or more biometric sensors (shown in FIG. 2) associated with the user's mobile device (via one or more of the authenticators 124 and/or 126). In some embodiments, the captured user biometric data is then transmitted by the web application 112 of the user's mobile device 102 via the Internet 106 (or another type of network connection) to the mobile payment application (MPA) 132 residing in the cloud computer system 110 for authentication processing. The web application 112 of the user mobile device 102 may also transmits user mobile device identification data, which may include the make, model number, operating system, IP address, and/or any other user device identification data that is associated with and that identifies the user mobile device 102 to the cloud computer system 110 running the MPA 132. In the present example, the purchase transaction data may include an entity identifier (such as a merchant identifier) and other data concerning the transaction, such as the total purchase transaction amount and/or the prices of particular items.

Referring again to FIG. 1, the cloud-based computer system 110 receives the user data and/or user mobile device data and utilizes the mobile payment application (MPA) 132 to identify the user, and then to identify which one of the user data structures 134, 136 or 138 should be utilized to authenticate the user. In addition, the MPA 132 utilizes entity identification data to identify the entity (i.e., the merchant) engaged in the purchase transaction, and thus to determine which of the user profiles (for example, cardholder profile CP1 for user1) to utilize for the transaction. For example, if the MPA 132 identifies the first user as involved in the purchase transaction, then the first user data structure 134, which is associated with that user (USER 1), is accessed. Next, the MPA 132 determines which user profile data (CP1 or CP2) to utilize. In the current example, the MPA determines, based on the entity identification data, that the second cardholder profile (CP2) 135B should apply to the purchase transaction. Upon review, CP2 includes one or more user authentication rules and/or device authentication rules and/or other policies of the entity (such as a merchant) involved in the transaction (such as a purchase transaction). Thus, in some implementations, the MPA compares the received user biometric data (captured and transmitted by the user's mobile device) to stored user biometric data (obtained, for example, during an enrollment process and then stored, for example, in a user authentication database) and generates a user validation indication when the captured biometric data of the user matches the stored biometric data. Similarly, the MPA 132 compares the received consumer device authentication data to stored user device authentication data, and if a match occurs then the MPA generates a user device validation indication. Lastly, if the user validation indication and the user mobile device validation indication satisfies the user authentication and consumer device authentication rules of the entity (for example, the entity requires fingerprint authentication and a password along with user device authentication) then the MPA 132 of the cloud computer system 110 transmits a positive authentication response message to the entity (such as the merchant computer 108) via the Internet 106. The positive authentication response message may indicate authentication of the user and authentication of the user mobile device in accordance with the rules and/or policies of the entity. Thus, in this example, the cloud computer system 110 is responsible for authenticating the user and the user consumer mobile device involved in the transaction on-behalf-of (OBO) the merchant to thus streamline the authentication process.

In some embodiments, the business rules data and/or policy data of an entity (such as the merchant) provide the requirements for what constitutes acceptable user authentication and/or user mobile device authentication techniques for most transactions, and in some cases may specify use of additional authentication levels for some types of transactions. Such determinations may depend on the transaction data associated with a particular transaction, or may be based on other considerations. Thus, in some implementations the online transactions are handled on a transaction-by-transaction basis, which allows for the user authentication required for any given transaction to be enhanced in some situations. For example, if a purchase transaction amount exceeds a predetermined threshold level defined by an entity (such as a total transaction amount equal to or greater than $100 dollars) then an enhanced level of user identification data (for example, provision of two or more forms of biometric data plus a mobile personal identification number (mPIN) and/or a password) in addition to user mobile device identification data may be required by the entity involved in the online transaction before user authentication and/or user mobile device authentication processing can be conducted. If the user does not provide the required identification data (or if the provided user identification data does not match pre-stored identification data) then the entity will receive a negative user authentication message from the cloud-based user authentication computer system. In such cases, the entity may decide to decline to consummate the online transaction and transmit a transaction declined message to the user.

However, in the case of a “normal” transaction (which may involve, for example, a “regular customer” or cardholder known to a merchant) or a transaction involving a de-minimis transaction amount (for example, a total transaction amount of twenty-five dollars or less), a minimal level of user identification data and/or user mobile device identification data (such as entry of a personal identification number (PIN) or user mobile device model type identifier) may be the only requirement. Embodiments that utilize such considerations (which may be in the form of business rules of an entity involved in the transaction) may streamline the user authentication and user mobile device authentication process resulting in the speeding up of the transaction authorization process, leading to improved adoption of such authentication techniques and resulting in a reduction of declined transactions which are legitimate card not present (CNP) transactions.

FIG. 2 is a block diagram of an embodiment of a user mobile device 200 illustrating hardware aspects that may be utilized during user authentication and user mobile device authentication processing in accordance with some embodiments described herein. In this example, the user mobile device 200 is a mobile telephone that is capable of conducting online transactions and that may (but need not) have capabilities for functioning as a contactless payment device. In particular, the mobile device 200 may be a payment-enabled mobile telephone capable of online purchase transactions such as online purchase transactions, and may include hardware that is configured to provide novel functionality as described herein. In some other embodiments, however, novel functionality as described herein may result at least partially from novel software and/or middleware and/or firmware components that program or instruct one or more mobile device processors of the mobile device 200.

The mobile telephone 200 may include a conventional housing (indicated by dashed line 202) that contains and/or supports the other components of the mobile telephone. The mobile telephone 200 includes a mobile device processor 204 for controlling over-all operation, for example, it may be suitably programmed to allow the mobile telephone to engage in data communications and/or text messaging with other wireless devices and/or electronic devices, and to allow for interaction with web pages accessed via browser software over the Internet, as described herein. Other components of the mobile telephone 200, which are in communication with and/or are controlled by the mobile device processor 204, include one or more storage devices 206 (for example, program memory devices and/or working memory and/or secure storage devices, and the like), a subscriber identification module (SIM) card 208, and a touch screen display 210 for displaying information and/or for receiving user input.

The mobile telephone 200 also includes receive/transmit circuitry 212 that is also in communication with and/or controlled by the mobile device processor 204. The receive/transmit circuitry 212 is operably coupled to an antenna 214 and provides the communication channel(s) by which the mobile telephone 200 communicates via a mobile network (not shown). The mobile telephone 200 further includes a microphone 216 operably coupled to the receive/transmit circuitry 212, which the microphone 216 is operable to receive voice input from the user. In addition, a loudspeaker 218 is also operably coupled to the receive/transmit circuitry 212 and provides sound output to the user.

The mobile telephone 200 may also include a proximity payment controller 220 which may be a specially designed integrated circuit (IC) or chipset. The proximity payment controller 220 may be a specially designed microprocessor that is operably connected to an antenna 222 and may function to interact with a Radio Frequency Identification (RFID) and/or Near Field Communication (NFC) proximity reader (not shown), which may be associated, for example, with a Point-of-Sale (POS) terminal of a merchant. For example, the proximity payment controller 220 may provide information and/or data, such as a user's payment card account number, when the user is using the mobile device 200 to conduct a purchase transaction, for example, with a POS terminal of a merchant in a retail store location.

The user's mobile device 200 may include one or more sensors and/or circuitry that functions to provide and/or obtain user identification data and/or user authentication data from the user. For example, the user mobile device may be a Smartphone including one or more authenticators such as an integrated camera 222, global positioning sensor (GPS) circuitry 224, one or more motion sensors 226, a fingerprint sensor 228 and/or a biochemical sensor 230 that are operably connected to the mobile device processor 204. Some of the authenticators can be used to perform user authentication, and may also be functional to provide other types of data as well such as mobile device identification data. For example, the integrated camera 222 is operational to take digital pictures, and may be operable to read two-dimensional (2D) and/or three-dimensional (3D) barcodes to obtain information, and/or can be operated during a user authentication process to take a picture of the user's face and/or of other relevant portions of the user or of the immediate environment.

Referring again to FIG. 2, the GPS circuitry 224 may be operable to generate information concerning the location of the mobile telephone 200. In addition, the motion sensor(s) 226 may be operable to generate motion data, for example, that can be utilized by the mobile device processor 204 to authenticate a user. For example, data may be generated that can be used to identify the user's walking style or gait. In another example, the motion sensor(s) 226 may operate to generate force data associated with, for example, the force generated by the user's finger when he or she touches the touch screen 210. The fingerprint sensor 228 may include a touch pad or other component (not shown) for use by the user to touch or swipe his or her index finger when fingerprint data is required to authenticate the user in order to conduct a transaction (such as provide entry to a building). The biochemical sensor 230 may include one or more components and/or sensors operable to obtain user biological data, such as breath data and/or saliva from the user, and/or other types of biological data which may be analyzed and associated with the user of the mobile device 200.

In some embodiments, the data obtained by the motion sensor(s) 226, fingerprint sensor 228 and/or biochemical sensor 230, may be transmitted from the user's mobile device 200 to the cloud-based computer system 110 for analysis to identify and/or authenticate the user. For example, the cloud-based computer system may compare received biometric data and/or other user data to user data stored, for example, in a user database accessible by the cloud computer system 110. In addition, in some embodiments, the mobile device processor 204 and receiver/transmitter circuitry 212 may be operable to transmit cardholder data and/or user financial transaction data and/or user mobile device data to the cloud-based computer system for authentication processing. The mobile device processor 204 may also utilize the receiver/transmitter circuitry 212 to transmit GPS data, for example, to one or more entities (such as an issuer financial institution computer) regarding the current location of the user mobile device. The user mobile device 200 may also contain one or more other types of sensors, such as an iris scanner device (not shown) or other biometric sensor(s) capable of generating iris scan data of a user's eye, which may be useful for identifying biometric or other personal data of the mobile device user.

It should be understood that, in some implementations, more than one form of user identification data and/or user device identification data may be required to authenticate a user and/or user mobile device in order to conduct certain types of transactions. For example, if a consumer is attempting to utilized a mobile device to purchase an expensive item from an online merchant (for example, a wristwatch valued at more than one thousand dollars) then several different types of user biometric data may be required by the merchant in order to authenticate the user, and several different types of user mobile device identification data may also be required. In such cases, a merchant may require the user to provide several different forms of identification data, for example, provision of fingerprint data, photographic data representing the user's face, a password or personal identification number (PIN), a mobile device personal identification number (mPIN), global positioning service (GPS) data, and/or an Internet protocol (IP) address of the user mobile device, to securely authenticate the user and the user's mobile device before the purchase transaction is presented for purchase transaction authorization processing.

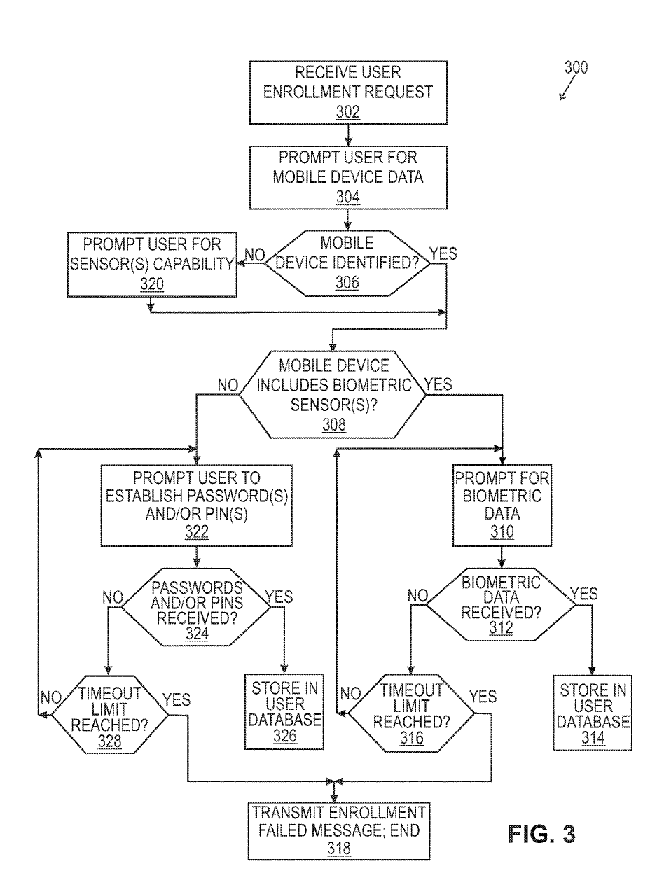

In some embodiments, users or consumers or cardholders may be required to enroll or register with the cloud-based authentication service computer system before being permitted to participate in the streamlined user authentication process in accordance with methods described herein. Thus, FIG. 3 illustrates a user enrollment process 300 according to some embodiments. In particular, a cloud-based authentication system computer receives 302 a user enrollment request from a user's mobile device. The enrollment request may include user identification data, such as the user's name and residence address and an e-mail address. The cloud-based authentication system computer may then prompt 304 the user to provide mobile device identification data, such as the mobile device type and/or the name of the model device and/or a serial number. The cloud-based authentication system computer may then try to identify 306 the mobile device, for example, by checking a database of mobile device types. If the mobile device is identified, then the cloud-based authentication system computer determines 308 if the mobile device includes one or more biometric sensor(s). If so, then the cloud-based authentication system computer prompts 310 the user to provide biometric data. In some embodiments, the user is prompted to provide biometric identification data for each type of biometric sensor and/or component supported by the user's mobile device. For example, if the user's mobile device includes a camera and a fingerprint sensor, then the user would be prompted to take a picture of his or her face (for facial recognition purposes) and to provide one or more fingerprints (from one or more fingers). When such biometric data is received 312 then it is stored 314 in a user database. The user biometric data and user mobile device identification data can then be utilized to generate one or more user profiles, wherein each user profile is associated with a particular entity. Each such user profile may also contain one or more business rules and/or policies promulgated by the entity that is/are applied to each transaction, dependent on transaction type and/or other considerations.

Referring again to FIG. 3, if in step 312 the biometric data is not received with in predetermined amount of time (typically in the range of about 15-30 seconds), and a time-out limit 316 has not been reached (typically in the range of about 30-90 seconds), then the user is again prompted 310 to provide the biometric data. However, if the required user biometric data again is not provided in step 312 and the time out limit is reached, then the cloud-based authentication system computer transmits 318 an enrollment failed message to the user's mobile device and the process ends.

Referring again to step 306, if the mobile device cannot be identified by the cloud-based authentication system computer, then the cloud-based authentication system computer prompts 320 the user for mobile device sensor(s) capabilities. If biometric sensors are available in step 308, then the cloud-based authentication system computer prompts 310 the user for biometric data and the process continues as explained above. However, if in step 308 it is determined that the user's mobile device does not contain any biometric sensors, then the cloud-based authentication system computer prompts 322 the user to establish one or more passwords and/or personal identification numbers (PINs). If the passwords and/or PINs are received 324 within a predetermined amount of time (typically within the range of about 15 to 30 seconds), then the passwords and/or PINs are stored 326 in the user database. The user passwords and/or PINs and the user mobile device identification data can then be utilized to generate one or more user profiles associated with the user, wherein each user profile is associated with a particular entity. As mentioned earlier, each such user profile may also contain one or more business rules and/or policies promulgated by the entity that is/are applied to each transaction, dependent on transaction type and/or other considerations.

Referring again to step 324, if the passwords and/or PINs are not received within the predetermined amount of time, then the cloud-based authentication system computer checks 328 if a predetermined timeout limit has been reached (typically in the range of about 60-90 seconds), and if not then the user is again prompted 322 to establish that data. But if the timeout limit is reached in step 328, then as before the cloud-based authentication system computer transmits 318 an enrollment failed message and the process ends.

Thus, a user may follow a process flow such as that illustrated by FIG. 3 to register or enroll by providing user identification data that may include one or more different types of biometric data items and/or passwords and/or PINs. For example, a user may utilize his or her user mobile device to generate biometric data, such as fingerprint data, voice data (i.e., a voice print), and/or facial data, which is then uploaded to the cloud-based authentication service computer system. In addition, other sensors or components could be utilized to generate and upload other types of user identification data, such as pulse data (i.e., heartbeat data), gait data (i.e., walking style data), and/or the like. Such user biometric data can then be stored in a user database associated with and accessible by the cloud-based authentication service computer system and then utilized to perform user authentication processing on behalf of a plurality of different types of entities and for a wide variety of different types of transactions and/or applications. In particular, the cloud-based authentication computer system may create one or more user or consumer profiles associated with a particular user that includes a combination of user identification data, user mobile device identification data, and one or more business rules and/or policies of one or more entities, wherein the user profiles can then be used by the transaction application of the cloud-based authentication computer system to authenticate a user in accordance with criteria provided by an entity. It should also be understood, however, that when the user's mobile device does not include any biometric sensor capabilities and thus user biometric identification data cannot be provided by the user, the user may be blocked from consummating certain types of transactions because an entity may not accept the use of passwords and/or PINs alone in the absence of user biometric identification data due to the entity's business rules and/or policies.

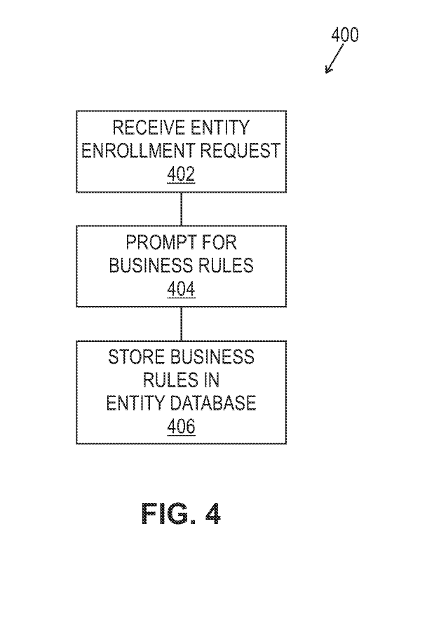

FIG. 4 is a flowchart illustrating an entity enrollment process 400 in accordance with some embodiments. In particular, a cloud-based authentication system computer receives 402 an entity enrollment request, for example, from an entity device such as a merchant server computer. The enrollment request may include entity identification data, such as the name of the entity, business address data associated with one or more stores, website identification data, and contact information. The cloud-based authentication system computer may then prompt 404 the entity to provide one or more business rules and/or policies of the entity that are to be utilized when conducting transactions with users, such as consumers shopping online by using the entity's website. Upon receipt, the cloud-based authentication system computer stores 406 the business rules data and/or policy data in an entity database. The business rules data and/or policy data are then utilized along with user identification data and user mobile device data to formulate user profiles, wherein each user profile is associated with that entity. Each such user profile therefore includes the business rules of the entity (along with any policy considerations) that will be utilized to determine whether or not to authenticate a user who wishes to engage in a particular type of transaction with that entity.

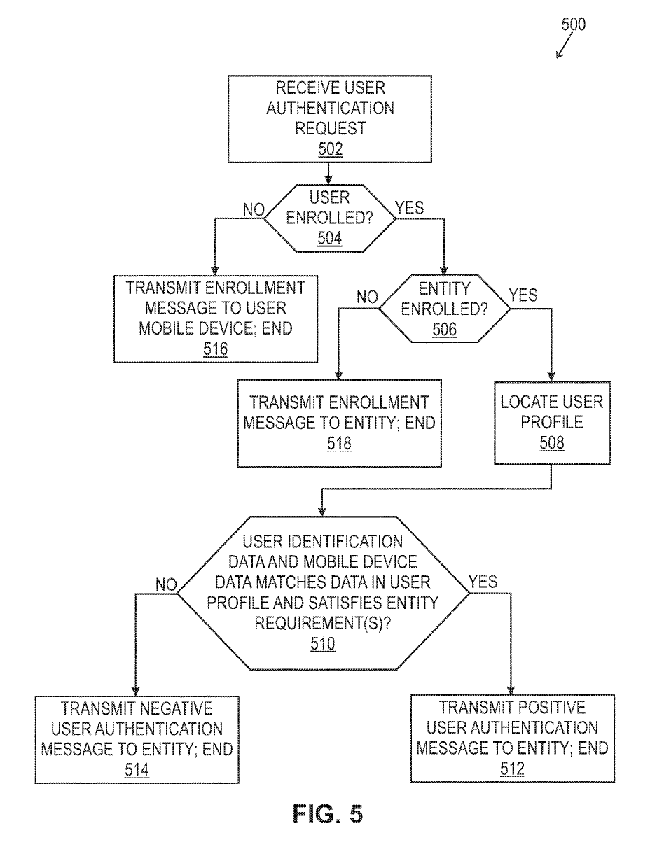

FIG. 5 is a flowchart illustrating a user authentication process 500 in accordance with some embodiments. The cloud-based authentication computer system receives 502 a user authentication request from a user mobile device, which request may include user authentication data (which may include one or more items such as a mobile personal identification number (mPIN) and/or user biometric data), user mobile device identification data, and transaction data (which may include items such as entity identification data, transaction amount data, transaction details data such as a time of day, and the like). The cloud-based authentication computer system then determines 504, based on at least a portion of the user authentication data, whether or not the user has enrolled in the cloud-based authentication service. If so, then the cloud-based authentication computer system determines 506, based on at least a portion of the transaction data, whether or not the entity involved in the transaction has enrolled in the cloud-based authentication service. If the user and the entity are both enrolled, the cloud-based authentication computer system locates 508 the appropriate user profile and then determines 510, based on the contents of the user profile (data stored in the user profile), whether or not the received user identification data and user mobile device identification data matches that of the user profile data. The cloud-based authentication computer system also determines 510 whether the type of user authentication data and/or the mobile device identification data satisfies the requirement(s) of the entity with regard to the transaction (for example, for that particular type of transaction, a requirement may be that the user provided two forms of biometric data that matched stored biometric data). If both a match occurs and the requirements are satisfied, then the cloud-based authentication computer system transmits 512 a positive user authentication message to the entity and the process ends. However, if the received user identification data and user mobile device identification data does not match the stored user data and/or the requirements of the entity are not satisfied, then the cloud-based authentication computer system transmits 514 a negative user authentication message to the entity and the process ends.

Referring again to step 504 in FIG. 5, if the user is not enrolled in the cloud-based authentication service, then the cloud-based authentication computer system transmits 516 an enrollment message to the user mobile device and the process ends. In some embodiments, the enrollment message includes contact information and enrollment instructions so that the user can enroll or register to utilize the cloud-based authentication service, for example, as explained above with regard to FIG. 3.

Referring again to step 506 in FIG. 5, if the entity involved in the transaction is not enrolled in the cloud-based authentication service, then the cloud-based authentication computer system transmits 518 an enrollment message to the entity involved in the transaction and the process ends. In some embodiments, the entity enrollment message includes contact information and enrollment instructions so that the entity can enroll or register to utilize the cloud-based authentication service, for example, as explained above with regard to FIG. 4. In some implementations, however, even though the entity is not enrolled the user may be permitted to proceed with the user authentication and user mobile device authentication process for the transaction if the cloud-based authentication computer system is configured to conduct a default authentication process. In such cases, if the received user identification data and user mobile device identification data matches stored user identification data, then the cloud-based authentication computer system transmits a conditional positive user authentication message to the entity involved in the transaction for consideration. The conditional positive authentication message may include information concerning what type(s) of user identification data was utilized and how the positive authentication determination was made, and is not binding on the entity. The entity may then determine whether or not to accept the determination of the cloud-based authentication computer system or to conduct some other type of user authentication processing.

It should be understood that users and/or consumers and/or cardholders may register a number of user mobile devices pursuant to the processes presented herein. Further, once a particular user mobile device has been registered, the provided user identification data may be used to authenticate the user with regard to different types of transactions involving different methods, which may depend upon requirements or criteria that may be provided by an entity. In addition, in some embodiments the user can enroll or register multiple user mobile devices such that any of the user's registered mobile devices can be used in transactions requiring user and user mobile device authentication.

The above descriptions and illustrations of processes herein should not be considered to imply a fixed order for performing the process steps. Rather, the process steps may be performed in any order that is practicable, including the omission of one or more steps and/or the simultaneous performance of at least some steps.

Although the present invention has been described in connection with specific exemplary embodiments, it should be understood that various changes, substitutions, and alterations would be apparent to those skilled in the art and can be made to the disclosed embodiments without departing from the spirit and scope of the invention as set forth in the appended claims.

What is claimed is:

1. An user authentication process for an online transaction, comprising:
receiving, by a cloud-based authentication service computer system from a user mobile device, a user authentication request in association with an online transaction, the user authentication request comprising user authentication data, user mobile device identification data, and transaction data that includes entity identification data of an entity and a transaction amount;
determining, by a mobile transaction application running on the cloud-based authentication service computer system, that the user and the entity involved in the online transaction are both enrolled in a cloud-based authentication service;
identifying, by the mobile transaction application, a user data structure and a user profile based on the data submitted with the user authentication request;
determining, by the mobile transaction application, that the received user authentication data and user mobile device identification data matches data stored in the user profile;
determining, by the mobile transaction application, that a requirement of the entity stored in the user profile is satisfied by at least a portion of the data submitted with the user authentication request; and
transmitting, by mobile transaction application to an entity computer, a positive user authentication message indicating authentication of the user and authentication of the user mobile device.

2. The method of claim 1, further comprising, subsequent to receiving the user authentication request:
determining, by a mobile transaction application running on the cloud-based authentication service computer system, that the user involved in the online transaction is not enrolled in a cloud-based authentication service; and
transmitting, by a mobile transaction application, an enrollment message to the user mobile device.

3. The method of claim 1, further comprising, subsequent to receiving the user authentication request:
determining, by a mobile transaction application running on the cloud-based authentication service computer system, that the entity involved in the online transaction is not enrolled in a cloud-based authentication service; and
transmitting, by a mobile transaction application, an enrollment message to an entity computer.

4. The method of claim 1, further comprising, subsequent to identifying the user data structure and the user profile:
determining, by the mobile transaction application, that at least one of the received user authentication data and user mobile device identification data does not match data stored in the user profile; and
transmitting, by the mobile transaction application to an entity computer, a negative user authentication message indicating that at least one of the user and the user mobile device has not been validated.

5. The method of claim 1, further comprising, subsequent to identifying the user profile:
determining, by the mobile transaction application, that at least one requirement of the entity has not been satisfied with regard to the online transaction; and
transmitting, by the mobile transaction application to an entity computer, a negative user authentication message indicating that at least one requirement of the entity has not been satisfied.

6. The method of claim 1, wherein the entity is a merchant.

7. The method of claim 1, wherein the user authentication data comprises at least one type of biometric data required to authenticate a user for the online transaction.

8. The method of claim 7, wherein the user authentication data comprises at least one of photographic data, facial data, fingerprint data and voice data.

9. An authentication system comprising:
at least one user mobile device comprising at least one authenticator; and
a cloud-based computer system in communication with the at least one user mobile device, the cloud-based computer system comprising a cloud-based processor operably connected to a storage device, wherein the storage device includes a mobile transaction application including instructions configured to cause the cloud-based processor to:
receive a user authentication request in association with an online transaction from a user mobile device, the user authentication request comprising user authentication data, user mobile device identification data, and transaction data that includes entity identification data of an entity and a transaction amount;
determine that the user and the entity involved in the online transaction are both enrolled in a cloud-based authentication service;
identify a user data structure and a user profile based on the data submitted with the user authentication request;
determine that the received user authentication data and user mobile device identification data matches data stored in the user profile;
determine that a requirement of the entity stored in the user profile is satisfied by at least a portion of the data submitted with the user authentication request; and
transmit a positive user authentication message to an entity computer, the positive user authentication message indicating authentication of the user and authentication of the user mobile device.

10. The system of claim 9, wherein the at least one authenticator comprises at least one of a digital camera, a fingerprint reader, a biochemical sensor, and a microphone.

11. The system of claim 9, wherein the mobile transaction application includes, subsequent to the instructions for receiving the user authentication request, further instructions configured to cause the cloud-based processor to:
determine that the user involved in the online transaction is not enrolled in a cloud-based authentication service; and
transmit an enrollment message to the user mobile device.

12. The system of claim 9, wherein the mobile transaction application includes, subsequent to the instructions for receiving the user authentication request, further instructions configured to cause the cloud-based processor to:
determine that the entity involved in the online transaction is not enrolled in a cloud-based authentication service; and
transmit an enrollment message to an entity computer.

13. The system of claim 9, wherein the mobile transaction application includes, subsequent to the instructions for identifying the user data structure and the user profile, further instructions configured to cause the cloud-based processor to:
determine that at least one of the received user authentication data and user mobile device identification data does not match data stored in the user profile; and
transmit a negative user authentication message to an entity computer, the negative authentication message indicating that at least one of the user and the user mobile device has not been validated.

14. The system of claim 9, wherein the mobile transaction application includes, subsequent to the instructions for identifying the user profile, further instructions configured to cause the cloud-based processor to:
determine that at least one requirement of the entity has not been satisfied with regard to the online transaction; and
transmit a negative user authentication message indicating that at least one requirement of the entity has not been satisfied.

15. The system of claim 9, wherein the instructions for receiving the user authentication request in association with an online transaction from a user mobile device comprise instructions configured to cause the cloud-based processor to receive at least one type of biometric data required to authenticate a user for the online transaction.
